(19) United States
(12) Patent Application Publication
(10) Pub. No.: US 2012/0128500 A1
(43) Pub. Date: May 24, 2012

(54) TURBINES

(75) Inventors: Robert Perless, Greenwich, CT (US); B. Holt Thrasher, Greenwich, CT (US); Talbot P. Thrasher, Cumberland, MD (US)

(73) Assignee: Arcjet Holdings LLC, Greenwich, CT (US)

(21) Appl. No.: 13/113,650

(22) Filed: May 23, 2011

Related U.S. Application Data
(63) Continuation-in-part of application No. 13/086,106, filed on Apr. 13, 2011.
(60) Provisional application No. 61/323,956, filed on Apr. 14, 2010.

(51) Int. Cl. F03D 1/06; F01D 5/14

(52) U.S. Cl. 416/223 R

(57) ABSTRACT

The invention generally relates to turbines that efficiently process air or fluid flow while producing substantially no vibrational effects. In one embodiment, the invention provides a turbine including a rotatable shaft and three helical blades connected to the rotatable shaft, where each of the blades has a helical twist of about 360°.

### CROSS-REFERENCE

This is a continuation-in-part of U.S. patent application Ser. No. 13/086,106, filed Apr. 13, 2011, which itself claims priority to and the benefit of provisional U.S. patent application Ser. No. 61/323,956, filed Apr. 14, 2010. The entirety of each of these two patent applications is incorporated herein by reference.

### TECHNICAL FIELD

The invention generally relates to a turbine with multiple helical blades and that efficiently process air or fluid flow while producing substantially no vibrational effects.

### BACKGROUND

Wind power refers to the conversion of wind energy into a useful form of energy, such as electricity. Wind energy is an attractive alternative to fossil fuels because it is plentiful, renewable, widely distributed, clean, and produces no greenhouse gas emissions. Wind energy accounts for about 1.5% of worldwide electricity usage, and approximately eighty countries around the world use wind power on a commercial basis (World Wind Energy Report 2008: Report, World Wind Energy Association, February 2009; and Worldwatch Institute: Wind Power Increase in 2008 Exceeds 10-year Average Growth Rate, May 2009). Further, world wind generation capacity has more than quadrupled between the years 2000 and 2006, doubling about every three years.

Wind energy is typically obtained from two sources. Large scale wind farms (i.e., a set of individual turbines that are interconnected to a power collection system and communications network) are used to generate power for small communities and larger cities. In contrast, small-scale wind turbines are wind generation systems used for electricity generation for individual commercial or residential buildings.

A problem with small-scale turbines is the vibrational effects that they generate during operation and power production. Vibrational effects are translated throughout a building, resulting in shaking of the building or even structural cracking Vibrational effects also produce a great amount of wear on the turbine itself (e.g. the blades, axle, and bearings). Another problem with small scale turbines is that they process turbulent airflow inefficiently. That is a particular problem in urban environments in which surrounding buildings disrupt airflow, thus increasing turbulence.

There is a need for turbines that deliver power to a generator while producing substantially no vibrational effects and that operate efficiently in an urban environment.

### SUMMARY

The invention generally relates to turbines that efficiently process air or fluid flow while producing substantially no vibrational effects. It has been found that the degree of twist of a turbine's helical blade influences vibrational effects and also affects the ability of a turbine to process turbulent air or fluid flow. Turbines of the invention include a plurality of helical blades, each having a degree of helical twist (measured in degrees) such that vibrational effects from rotation of the blades are substantially eliminated while the turbine operates. Further, the helical twist of each of the helical blades also allows the turbine to efficiently process any type of air flow, particularly turbulent air flow. Since turbines of the invention can operate while producing substantially no vibrational effects and can efficiently process turbulent air flow, turbines of the invention are ideal for power production for commercial or residential buildings, particularly buildings in an urban environment as well as rural and coastal areas.

Turbines of the invention include a rotatable shaft and at least one helical blade connected to the rotatable shaft. Each of the turbine's blades has a helical twist that results in elimination of substantially all vibrational effects from rotation of the blades while the turbine operates. An exemplary degree of helical twist of each of the blades of a turbine of the invention is about 180° or greater. Each blade's helical twist can be about 270° or greater, or about 360° or greater. In a particular embodiment, three helical blades are used, and each of the three helical blades of the turbine has a helical twist greater than 270° but less than 450°, and preferably a helical twist of 360° or about 360°.

Each of the turbine's blades may include various features that enhance operation without producing vibrational effects. For example, each of the blades may include a bulbous portion at a leading edge of the blade. Each blade can include a winglet at a trailing edge of the blade. Each blade can have a cross section of any of a variety of shapes. Each blade can be an airfoil. Each blade may be constructed using any of a variety of materials or combinations of materials. Each blade can have a foam core covered with a carbon fiber shell, a fiberglass composite shell, or a polymeric shell. Each blade can have a hollow interior and a carbon fiber shell, a fiberglass composite shell, a polymeric shell, or a metal shell.

Turbines of the invention may have many different uses, such as a wind turbine or a water turbine. In a particular embodiment, the turbine is a wind turbine. In certain embodiments, turbines of the invention are unidirectional turbines, which refers to a turbine that is capable of rotating regardless of the direction of air or fluid flow. Thus, the turbines do not need to be pointed into the direction of the wind or fluid to be effective.

It has also been found that the degree of twist of each of the turbine's blades effects the efficiency at which the turbine processes wind. In fact, at a certain helical twist degree, the turbine's helical blades will rotate about the shaft of the turbine at a speed greater than actual wind speed.

### BRIEF DESCRIPTION OF THE DRAWINGS

FIG. 1 shows an exemplary three-blade turbine of the invention, each of the three blades having a helical twist of 270° or about 270°.

FIG. 2 provides a schematic cross-sectional side view of a turbine illustrating zones of thrust efficiency.

FIG. 3 shows an example of a prior art vertical-axis turbine.

FIG. 4 is a schematic showing the airfoil shaped cross section of blades of turbines of the invention.

FIG. 5 is picture showing a magnified view of a bulbous portion at a leading edge of a blade of a turbine of the invention.

FIG. 6 provides an illustrative schematic for calculating dimensions of a bulbous portion.

FIG. 7 is picture showing a magnified view of a winglet at a trailing edge of a blade of a turbine of the invention.

FIG. 8 is a schematic showing a top view of a multi-blade turbine of the invention.

FIG. 9 is a graph showing that turbines of the invention (one with a helical blade twist of 180°, and another with a helical blade twist of 270°) produce substantially no vibrational effects during operation.

FIG. 10 shows another exemplary three-blade turbine according to the invention, each of the three blades having a helical twist of 360° or about 360°.

FIG. 11 is a graph of a power curve showing calculated kilowatt per hour (KW/Hr) based on testing of the turbine of FIG. 10.

### DETAILED DESCRIPTION

Turbines of the invention include a rotatable shaft and at least one blade connected to the rotatable shaft. Turbines of the invention are configured to operate without producing substantial vibrational effects and to efficiently process air flow, particularly turbulent air flow. Elimination of vibrational effects during operation and ability to efficiently process air flow makes turbines of the invention ideal for power generation for a residential or commercial building.

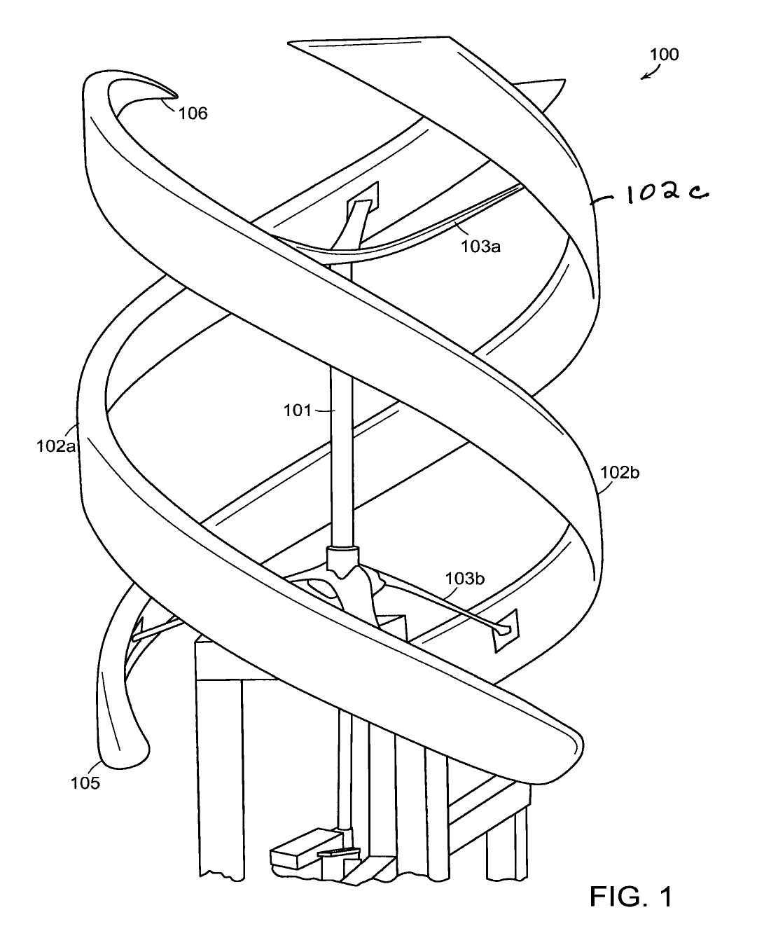

FIG. 1 shows an exemplary turbine 100 of the invention. Turbine 100 includes a rotatable shaft 101 and at least one blade 102. The rotatable shaft 101 may be made from any suitable material, such as metals, plastics, or polymers. In certain embodiments, the rotatable shaft is made from aluminum. The turbine shown in FIG. 1 includes three blades, 102a, 102b, and 102c. However, turbines of the invention may include only a single blade or may include two or more blades, such as four blades, five blades, six blades, etc. The blades 102 may be made from any suitable material, such as metals, plastics, foams, polymers, or a combination thereof. In an exemplary embodiment, the turbine blades have a foam core for an interior of the blade, which is then covered with a carbon fiber, fiberglass composite, metal, or polymeric shell. In other embodiments, the interior of the blade is hollow and the blade is constructed as a carbon fiber, fiberglass composite, metal, or polymeric shell.

The blades 102a, 102b, and 102c are connected to the rotatable shaft 101 by connecting members 103. FIG. 1 shows two connecting members 103a and 103b, however more or less connecting members may be used. In certain embodiments, only a single connecting member is used. In other embodiments, more than two connecting members are used. The number of connecting member will depend on numerous factors, such as the dimensions of the turbine or the environmental surrounding of the turbine (e.g., high wind speed area, low wind speed area, turbulent wind area, proximity to other buildings, where the turbine is mounted, etc.). Since the blades 102 are fixedly mounted to the rotatable shaft 101, rotation of the blades 102 results in rotation of the shaft 101.

Each of the connecting members 103a and 103b is shown having radial spokes, and each of the spokes connects at its end (away from the connecting member's central hub) to one of the blades 102a-102c. The radial spokes may be made from any materials, such as metals, plastics, polymers, or combinations thereof. In certain embodiments, the connecting members are made from aluminum. While FIG. 1 shows the connecting members 103 as radial spokes, numerous other configurations may be used, such as discs.

Blades 102a-102c are shown to have a helical shape. The helical shape of each of the blades enhances the ability of the turbine to operate without producing vibrational forces. The helical shape also enhances the ability of the turbine to process turbulent air flow. The helical shape of the blades 102 allows turbines of the invention to operate as vertical-axis turbines, such as shown in FIG. 1 where the rotatable shaft 101 is perpendicular to the ground.

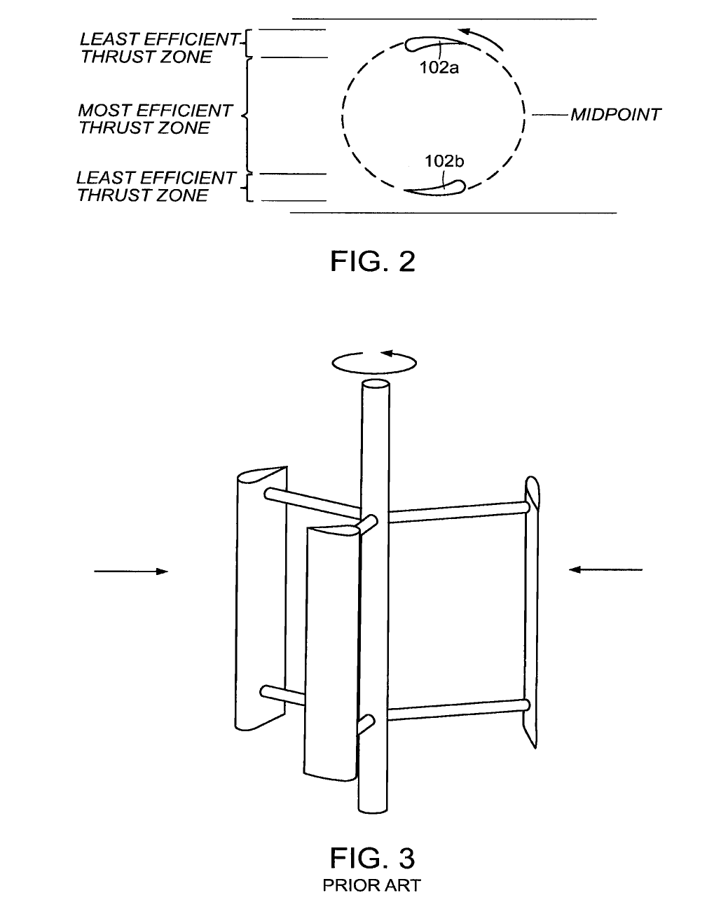

A typical problem with prior art vertical-axis turbines is a pulsing effect that is generated during operation of the turbine. FIG. 2 provides a schematic cross-sectional side view of a turbine illustrating zones of thrust efficiency. As shown in FIG. 2, the least efficient thrust zones are at the outer edges and the most efficient thrust zone is near the center. FIG. 2 shows that the efficiency of the thrust varies continuously from a minimum at a first outer edge, to a maximum at a midpoint, to a minimum at a second outer edge. It is the different efficiencies of the thrust of the air or fluid with respect to the prior art turbine blades that generate the pulsing effect. FIG. 3 shows an example of a prior art vertical-axis turbine. Those turbines operate with a strong pulsation due to accelerations and decelerations as the blades pass discontinuously through the most efficient and least efficient thrust zones. The pulsing effect results in production of vibrational forces, which are detrimental to the turbine or any building that the turbine is associated with.

The helical configuration of the blades of the turbines of the invention ensures that a portion of the blades 102 are always positioned optimally with respect to air or fluid flow. The continuous helical blades provide a continuous speed of rotation uninterrupted by accelerations and decelerations that accompany other prior art turbines, such as shown in FIG. 3, as the blades pass through the least and most efficient thrust zones. The helical blades may be divided into two halves, in which one half is a left-handed helix and the other half is a right-handed helix. In this manner, the components of the thrust force that extend parallel to the rotatable shaft 101 cancel each other out. However, all left-handed or all right-handed helixes or any other suitable helical configuration may be provided if desired.

While the helical shape of the blades reduces the pulsing effect seen with prior art vertical-axis turbines, thus also reducing vibrational effects, it has been found that the helical shape alone does not eliminate vibrational effects that occur while the turbine operates. It has been found that the angle or twist of each helical blade of a turbine influences vibrational effects that the turbine produces while operating. It is this helical twist angle (measured in degrees) that leads to elimination of substantially all vibrational effects produced from a turbine's helical blades while the turbine is operating. As shown in FIG. 1, each of the helical blades 102 of a turbine 100 of the invention is designed to have such a twist that substantially all vibrational effects are eliminated while the turbine is operating. Thus, each of the helical blades 102 may have any twist degree that results is elimination of substantially all vibrational effects while the turbine is operating. Each of the blades 102a-102c shown in FIG. 1 has an angle of about 270°. However, each of a turbine's helical blades may have some other degree of helical twist that also eliminates substantially all vibrational effects, such as about 180°, about 360° or greater, about 450° or greater, about 540° or greater, about 630° or greater, or about 720° or greater. Other exemplary degrees of helical twist of each helical blade of a turbine of the invention include about 185°, about 190°, about 195°, about 200°, about 210°, about 220°, about 230°, about 240°, about 250°, about 260°, about 270°, about 280°, about 290°, about 300°, about 310°, about 320°, about 330°, about 340°, about 350°, about 355°, about 360°, about 365°, about 370°, about 375°, about 380°, about 385°, about 390°, about 400°, about 405°, about 450°, about 495°, about 540°, about 585°, about 630°, about 675°, or about 720°. When a turbine of the invention has multiple helical blades, each of the turbine's blades typically will have the same or about the same helical twist degree or angle. Again, each of the blades 102a-102c of the exemplary turbine shown in FIG. 1 has a helical twist of about 270°.

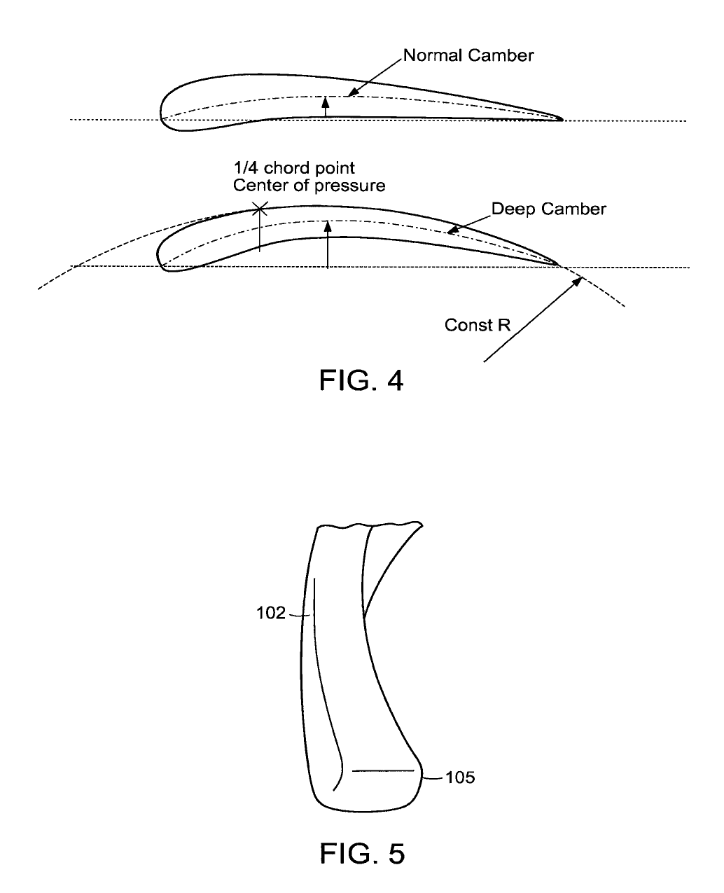

In certain embodiments, the blades 102 have a cross section shape that is an airfoil. However, blades for the turbines of the invention may have a cross section that is any shape. FIG. 4 is a schematic showing the airfoil shaped cross section of blades 102. In certain embodiments, the blades have increased deep camber to accommodate rotational motion of the turbine. Camber refers to the asymmetry between the top and the bottom curves of an airfoil in cross-section. Camber is added to an airfoil to increase lift and/or increase the critical angle of attack. FIG. 4 panel A provides a schematic of a blade having normal camber. FIG. 4 panel B provides a schematic of a blade having increased deep camber. The increased deep camber in blades of turbines of the invention provides for increased lift and ease of start-up from a stationary position, e.g., turbines of the invention may be self-starting.

Blades for the turbines of the invention may include numerous other features that enhance the ability of turbines of the invention to operate without producing substantial vibrational effects. In certain embodiments, the blades 102 are configured such that each point of the blade is a uniform distance from the rotatable shaft 101, as shown in FIG. 4 panel B.

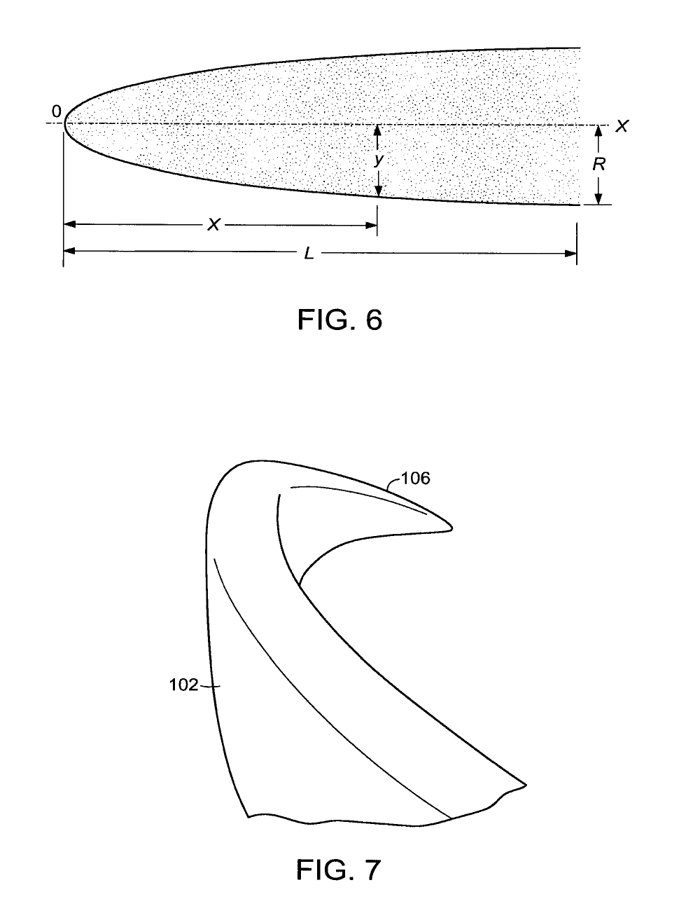

In other embodiments, blades 102 of the invention include a bulbous portion 105 at a leading edge of the blades 102 (FIGS. 1 and 5). The bulbous portion can be of any dimensions depending on the amount of aerodynamic resistance and friction drag that is desired. Generally, the dimensions of the bulbous portion 105 will depend on the dimension of the blades 102, and the bulbous portion will be designed to minimize aerodynamic resistance and friction drag. Methods of designing a bulbous portion are known in the art. See for example, Department of Defense Military Design Handbook (1990), Design of Aerodynamically Stabilized Free Rockets; and Chin SS. (1961), Missile Configuration Design, McGraw-Hill Book Co., Inc., New York, the content of each of which is incorporated by reference herein in its entirety. FIG. 6 provides a schematic of a bulbous portion 105. Generally, L is the overall length of the bulbous portion and R is the radius of the base of the bulbous portion 105. y is the radius at any point x, as x varies from 0, at the tip of the bulbous portion 105, to L. The equation defines the 2-dimensional profile of the bulbous portion 105. The full body of revolution of the bulbous portion 105 is formed by rotating the profile around the centerline (C/L). Note that the equation describes the “perfect” shape; practical nose cones are often blunted or truncated for manufacturing or aerodynamic reasons.

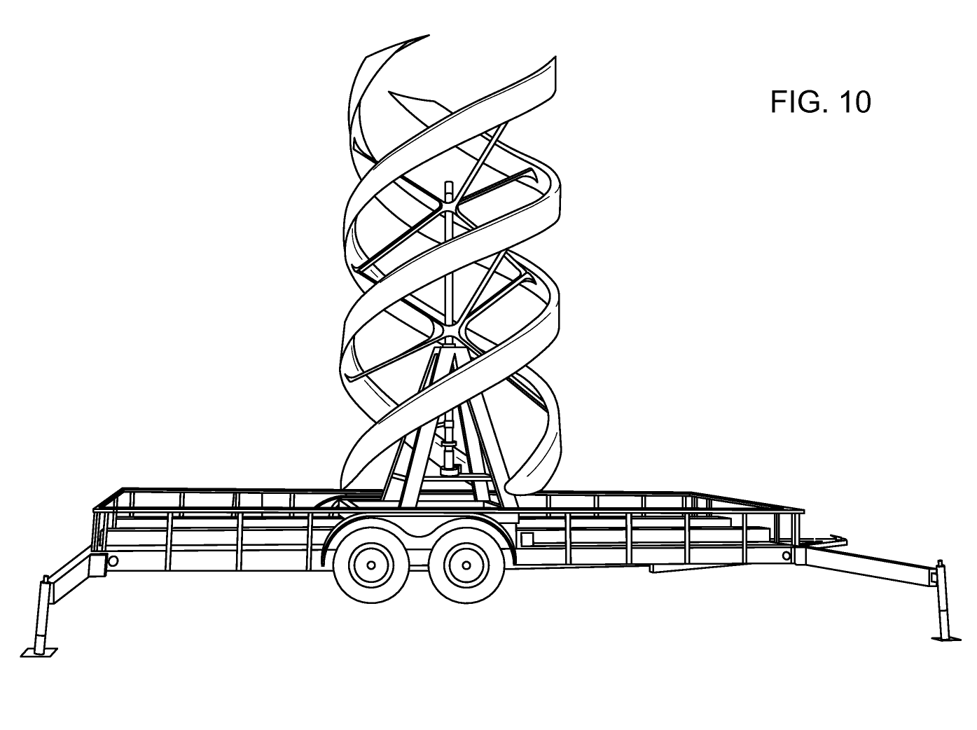

It is noted that, for one or more embodiments of a turbine according to the invention (such as the turbine 1000 of FIG. 10), the bulbous portion at the leading edge can be more of a round bulb. As compared to that shown in FIG. 5, a rounder bulb is an alternative embodiment of the bulbous portion at the leading edge.

Whatever specific dimensions it has in any particular blade embodiment of a turbine according to the invention, the bulbous portion promotes lamination of the air or fluid through which the bulbous portion passes. This is in contrast to a non-bulbous, more knife-like leading edge that promotes many vortices and turbulence as it pushes its way through the air or fluid.

In certain embodiments, one or more of the blades 102 of the invention includes a winglet 106 at a trailing edge of the blade 102 (FIGS. 1 and 7). The winglet 106 provides additional stabilization to the blade 102 as it rotates. The increased stabilization leads to further reduction of any vibrational effects that are generated during operation of turbines of the invention. Further, winglet 106 reduces drag of blades 102 by altering the airflow near the trailing edge of the blades 102. The winglet 106 also increase the lift generated at the trailing edge of the blades 102 (by smoothing the airflow across the blade near the trailing edge) and reduces the lift-induced drag caused by vortices generated at the trailing edge of the blades 102, improving lift-to-drag ratio.

When turbines of the invention are operating, vortices are produced at the trailing edge of the blades 102 that rotate around from below the blade, striking the surface of the blades 102, and generating a force that angles inward and slightly forward. The winglet 106 converts some of the energy from those vortices into thrust. The upward angle (or cant) of the winglet 106, its inward or outward angle (or toe), as well as its size and shape effect turbine performance. Winglet 106 can be oriented at any angle with respect to the trailing edge of the blade 102. Exemplary angles include 5°, 10°, 20°, 45°, 90°, 120°, or 270°. In certain embodiments, the winglet 106 is oriented at 90°, or perpendicular, to the trailing edge of wing 102 (FIGS. 1 and 7).

Winglets 106 also increase efficiency by reducing vortex interference with laminar airflow near the trailing edge of the blades 102, by moving the confluence of low-pressure and high-pressure air away from the surface of the blades 102. Vortices generate turbulence at the trailing edge of the blades 102, which turbulence delaminates the airflow over a small triangular section of the trailing edge of the blades 102, which destroys lift in that area. The winglet 106 drives the area where the vortex forms upwards away from the blade surface.

The lift-drag relationship allows for a generation of thrust by the airfoil shaped blades 102. As discussed above, the blades 102 have a high camber profile in certain embodiments in which the camber is premised on an outer airfoil surface with a constant circumferential radius that allows for the outer surface of the wing behind the ¼ chord point to rotate around the center of rotation maximizing laminar flow and minimizing trailing edge turbulence and thus thrust loss (FIG. 4). The inner surface of the wing behind the ¼ chord point is constrained to accommodate a consistently tapered section for aerodynamic optimization (FIG. 4). The chord length and rotation diameter are balanced to allow for a circumference coverage, consistently along the vertical helix, of less than 25% to allow for air and fluid flow between the blades (FIG. 4). This will minimize blade trailing edge turbulence effects on the following leading edge flow. This spacing will improve the aerodynamic lift to drag ratio capability. The bulbous portion forward of the ¼ chord point may be a symmetric bull nose rotated to a tangential arrangement of the direction of rotation.

The blades 102 may be designed with any width to height ratio that is desired. The width to height ratio of the blades will depend on numerous factors, such as the dimensions of the turbine or the environmental surrounding of the turbine (e.g., high wind speed area, low wind speed area, turbulent wind area, proximity to other buildings, where the turbine is mounted, etc.). In certain embodiments, the blades 102 have a width to height ratio of 1 width to 1.5 height.

Turbines of the invention are unidirectional turbines, which refers to a turbine that is capable of rotating regardless of the direction of air or fluid flow. Thus, the turbines of the invention do not need to be pointed into the direction of the wind or fluid to be effective. Regardless of the direction of air or fluid flow, blades of the turbine rotate in the same direction, the direction of the leading edge of the blades. Turbines may be oriented in any direction with respect to the ground, such as horizontally, vertically, or angled. FIG. 1 shows an embodiment in which the turbine is oriented as a vertical-axis turbine. In certain embodiments, the turbines of the invention are oriented such that the blades are mounted transversely to the direction of air or fluid flow for rotation in a plane parallel to the direction of air or fluid flow.

Turbines of the invention may be fabricated and manufactured using methods well known by one of skill in the art. An exemplary protocol for manufacturing a turbine of the invention is provided here. The manufacture of the turbines is based on a foam core composite skin sandwich structure, which are pre-fabricated and then attached to welded aluminum connecting members configured around a center rotatable axis. Briefly, an inner diameter mold is produced using a barrel shaped form. A cylindrical frame constructed of wood members is covered using a pliable thin sheet material to produce a constant diameter cylinder. Small cross section thermoplastic foam wing sections are cut into an airfoil shape and bonded together on the foam cylinder along a helical scribe line to ensure a constant rotation angle up the cylinder. The bonded foam core is then hand shaped to the prescribed airfoil configuration using shaping tools and/or patterns.

The foam core assembly is then cover with two layers of Egyptian cotton fabric, which had been saturated with an epoxy resin and smoothed to the surface contour of the foam core. This method produces a standard sandwich structure as a cocured composite skin construction. The skin materials are then allowed to cure. The materials are subsequently hand sanded for aerodynamic smoothness as well as aesthetics. Winglets and bulbous portions are then fabricated using a similar method of thermoplastic foam cores and then secondarily bonded to the ends of each blade.

The blades are then attached to aluminum welded radial spokes. The radial spokes are constructed to create a center of rotation based on a symmetric helical rotation dynamic. The radial spokes are constructed with an attachment angle that extends from the center but is not perpendicular the vertical axis of rotation. This angle is replicated at the opposite angle from its opposing radial spokes. The radial spokes are subsequently attached to the rotatable shaft.

The rotatable shaft is connected to a base using a standard two ring roller bearing attachment which allows for the shaft and thus the turbine to be held in a vertical position. This shaft positioning at the base allows for structural support and in tandem with a connection to an electrical generator below the turbine.

For larger and more substantial turbine blade construction, an alternate fabrication method is envisioned. Having a foam cavity mold in which the blade cores are pre-fabricated, with end details as well as pre-inserted attachment fittings (bosses, pre positioned hard points for attachments, or inserts) is a more efficient and consistent method for the core fabrication. This method allows for multiple identical part configurations, which can be subsequently, assemble into a 270°/360°/720° flexible turbine configuration from a set of easy to assemble components.

Furthermore, the use of carbon finer fabrics, tapes and other pre-form textile products as well as multiple resin options for varying end use conditions (i.e. weatherproof, UV, decorative, electrically insulative or conductive) is envisioned.

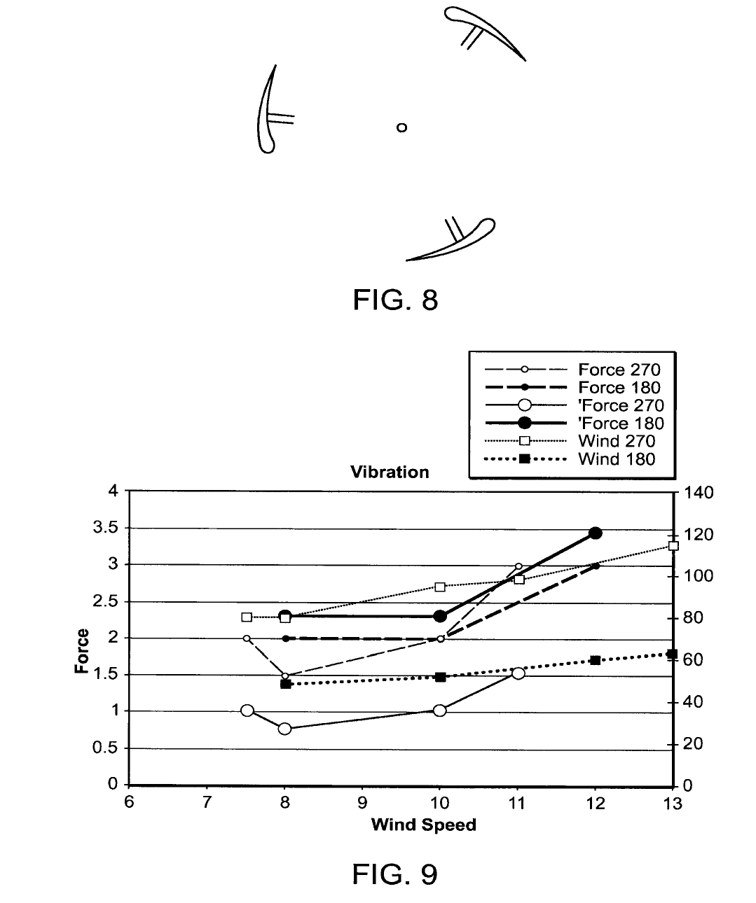

Given the blade construction and airfoil shapes described above, another embodiment of the turbines of the invention uses a multi-blade arrangement for improved balancing and constant power generating capability. By examining the cross section of the turbine from a top view (FIG. 8), the multiple blades exhibit their angle of attacks that are distinctly spaced with regard to the air/fluid flow. In this configuration, one blade will be at a higher lift generating angle at the same time that another blade is in a minimized lift and a (potentially maximized) drag angle, with the third somewhere in between still generating lift.

Since lift to drag ratios for airfoils normally range in the 20-1 region, depending on the angle of attack, the premise that two airfoils will be in higher lift to drag angle while one is in a 1:1 angle, a efficient statically overcoming force is generated to rotate the turbine. For example, two blades would have a 5:1 and 15:1 ratio with the third being at a 1:1 angle. The two high ratio blades will generate an overall rotational force on the turbine equal that far overcoming the one low performing blade. As the turbine rotates, the blades continuously alter their individual angles of attack. This would normally create a pulsed generating effect as seen in a prior art straight wing vertical windmill (FIG. 3). But, a turbine with one or more rotating helical blades, each with a helical twist of 360° or about 360°, results in a balanced angle of attack by the vanes causing a continuously constant multi-blade profile with regard to the fluid flow direction. Since each blade will have one section view in every possible angle of attack due to the 360° helical twist, the lift and thus thrust is continuous and stable with respect to the wind speed.

Since there are three equally spaced blades in the circumference of the rotation, the dynamic balance of the aerodynamic forces is constant. Because the largest portions of the mass of the rotating body (the blades) are at a maximum distance from the axis of rotation, the potential for out of balance mechanical forces is high. However, this is overcome by the lightweight structure of the blades of the turbines of the invention, which generate greater aerodynamic forces than rotational mass inertia forces. The open-ended radial spoke mounting of the blades (FIG. 1 for example) allows for non-perpendicular wind flow to be harnessed. The helical arrangement also optimizes this energy generating situation as the vertical fluid flow component will still see a balanced elongated airfoil cross sections, thus providing additional generation with the bulbous portion and attachment of winglets at the upper and lower ends.

Turbines of the invention may be connected in any suitable manner to an electrical generator by methods known in the art. In a further embodiment, turbines of the invention can be efficiently configured as an optimal unit or module and combined in a modular array to harness water or wind power. The power available from a prior art propeller turbine is proportional to the circumferential velocity of the blades, which increases with distance from the turbine shaft. Thus, prior art turbines are traditionally designed with a maximum diameter. However, the size of such prior art turbines is limited by their strength and possibility of structural failures caused by centrifugal forces and vibrations when the diameter becomes too large.

The turbines of the invention are advantageous in this regard, since its available power is proportional to a frontal rectangular area equal to the product of its diameter and its length, and the length is not related to angular velocity or centrifugal forces. Relatively small turbines of the invention can be optimized for airfoil profile, angular velocity, diameter, and length, and an entire power system can be assembled from such modules. Such a power system can exploit a common generator for a number of modules and is simple to build and maintain. One or more electrical generators are provided in communication with the array of turbines. A generator may be individually associated with each turbine, or plural turbines may be connected via a suitable transmission to a single generator. The array of turbines may be located in any suitable windy location, as is known in the art, for example for locating traditional windmill-type wind farms.

Further, traditional propeller-type wind turbines must be rotated to face the wind direction and sweep a circular cross-sectional area. In contrast, turbines of the invention are self-starting and provide uniform non-oscillating rotation, as compared to the prior art turbines. The turbines provide unidirectional rotation for any wind direction. Also, birds are likely to perceive the turbines of the invention as a solid wall, minimizing the danger of collisions for birds. Turbines of the invention may also be screened to prevent collisions with birds.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

### EXAMPLES

### Example 1

### Elimination of Vibrational Effects

Several turbines of the invention were constructed having helically shaped blades according to methods described above. Each of the turbines was constructed with a different degree of twist for the helical blades, 180° and 270° respectively. The turbines were tested in wind conditions to assess the vibrational effects on the structure to which the turbines were attached. Results of the test are shown in Tables 1-2 below and in FIG. 9.

TABLE 1
Turbine with blades having angle or twist of 180°

| Wind speed (mph) | Vibrational effects (force) |
|---|---|
| 8 | 2.30 |
| 10 | 2.30 |
| 12 | 3.45 |

TABLE 2
Turbine with blades having twist of 270°

| Wind speed (mph) | Vibrational effects (force) |
|---|---|
| 7.5 | 1.02 |
| 8 | 0.77 |
| 10 | 1.02 |
| 11 | 1.54 |

Data herein show that turbines of the invention generate substantially no vibrational effects during operation (Tables 1-2 and FIG. 9). Further, the data show that as the twist of the helical blades is increased from 180° to 270°, the vibrational effects generated by the turbine decrease (Tables 1-2 and FIG. 9). It was also observed that the turbine with the 270° twist helical blades rotated at approximately twice the speed of the turbine with the 180° twist helical blades and still produced substantially no vibrational effects.

### Example 2

### Rotational Speeds

Several turbines of the invention were constructed having helically shaped blades according to methods described above. Each of the turbines was constructed with a different degree of twist for the helical blades, 180° and 270° respectively. The turbines were tested in wind conditions to assess the rotational speeds in relationship to wind speed. Results of the test are shown in Tables 3-4 below.

TABLE 3
Turbine with blades having angle or twist of 180°

| Wind speed (mph) | Rotational speed of turbine (rpm) |
|---|---|
| 8 | 48 |
| 10 | 52 |
| 12 | 60 |

TABLE 4
Turbine with blades having twist of 270°

| Wind speed (mph) | Rotational speed of turbine (rpm) |
|---|---|
| 7.5 | 80 |
| 8 | 80 |
| 10 | 95 |
| 11 | 98 |
| 13 | 115 |

Data herein show that the turbine blade(s) rotated about the shaft of the turbine at a speed greater than actual wind speed.

### Example 3

### Test of a Three-Blade 360°-Twist Helical-Blade Turbine that is 15.5° by 7.5°

One tested embodiment of a turbine 1000 according to the invention has three helical blades, and each of the blades has a helical twist of 360° or about 360°, as shown in FIG. 10. Any one or more, or all, of the various shapes and features of the blades of the turbine 100 that are described herein are possible for and apply to the three blades of the turbine 1000. For example, each of the blades of the turbine 1000 can have a bulbous portion at its leading edge, as depicted in and described herein with respect to FIGS. 5 and 6. For the tested turbine 1000, however, it is noted that the bulbous portion at the leading edge is more of a round bulb than is shown in FIG. 5.

Before describing the results of the test of the turbine 1000, it also is noted that the turbine 1000 weighs about 250 lbs., is about 15.5 feet high and about 7.5 feet wide, and has a swept area of 116.3 square feet. And it is noted that each of the turbine's two connecting members (which serve the same function as the connecting members 103a, 103b of FIG. 1 and can be similarly configured and constructed) can have one, two, three, or more additional radial spokes (not shown). For example, the top connecting member of the turbine 1000 can have three additional spokes, each of which connects at its end (away from the top connecting member's central hub) to a spot on the inside of a different one of the helical blades about two feet in from the top end of the blade, and the bottom connecting member also can have three additional spokes, each of which connects at its end (away from the bottom connecting member's central hub) to a spot on the inside of a different one of the helical blades about two feet in from the bottom end of the blade. These additional radial spokes serve to further secure each of the three helical blades of the turbine 1000 to its rotatable shaft, and they thus ensure that each of the helical blades will remain intact at very high wind speeds. That is, neither the top ends of any of the three helical blades nor the bottom ends of any of the three helical blades will vibrate, bend, deflect, distort, or break when the turbine 1000 is exposed to wind speed greater than 35 mph such as wind speed of 100 mph.

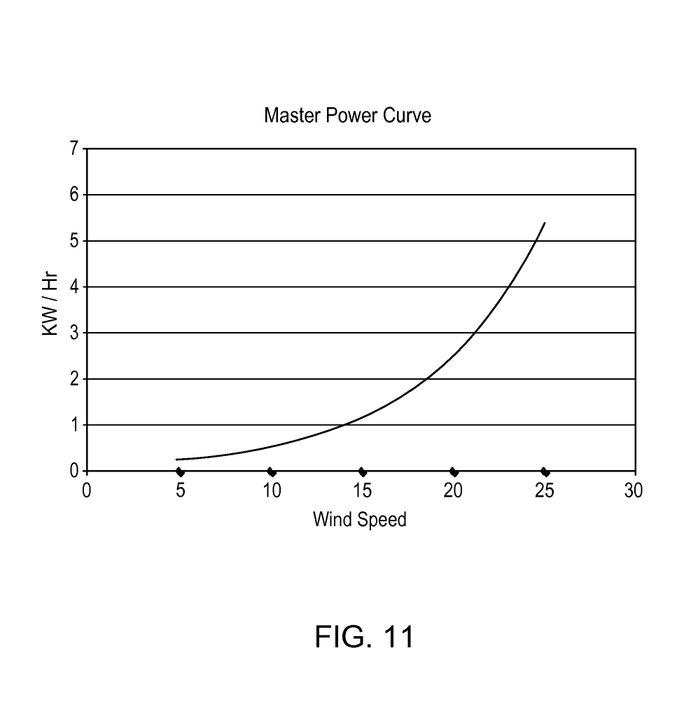

As indicated in FIG. 11, the turbine 1000, when tested, began rotating when exposed to a wind speed of about 5 mph, and it was calculated as being able to produce at least about 5900 Watts. Also, the calculated Watts per square feet of swept area is 50.8.

The testing involved using a fixed 250 horsepower engine to drive a screened fan with blade having a diameter of six feet. The fan produced mildly turbulent wind over a range of wind speeds starting at 5 mph and going to more than 30 mph, more particularly 5, 10, 15, 20, 25, 30, and 30+ mph. An anemometer was used to measure the wind speed. The fan was located on a wheeled trailer, and the turbine 1000 was located on a separate wheeled trailer. The wind generated by the fan was directed at the turbine 1000. The fan was located about 60 feet away from the turbine 1000.

The testing was performed over a period of several days. During the testing, various measurements were taken including the rotations per minute of the turbine's helical blades, the torque of the turbine's rotatable shaft (as an indication of the turbine's electricity output), and the distributed weight of the turbine's trailer (as an indication of wind loading), as well as temperature, humidity, and elevation measurements.

One test determined the force carried by the turbine 1000 on its trailer—wind loading. Up to a wind speed of 30 mph, the force on the platform was less than 55 lbs., and thus very small wind loading was observed. This indicates that placement of the turbine 1000 on the roof of a residential or commercial building will not require additional support(s) beyond a central base for the rotatable shaft of the turbine 1000.

In the testing of the turbine 1000 with wind speeds from zero to 30 mph, no measurable vibration was produced by the rotating turbine 1000. Vibration monitoring tools on the turbine's trailer did not detect any vibration. There was no blade pulse action or any cyclical movement. Similarly, the rotating turbine created no detectable operating noise when one stood away from it, although a slight wind noise could be heard by standing very close (such as about 1 foot) to the rotating turbine. That slight wind noise was similar to low-grade white noise and not a whining or a whistling noise. Standing that close to the rotating turbine 1000 also gave a slight feeling of wind buffering.

The turbine 1000 began spinning in a wind of less than 1 mph, although it is noted that this occurred when nothing was attached to the turbine's rotatable shaft. Thus, a wind speed of about 1 mph or less is all that is needed to overcome the turbine's standing inertia caused by the load of the three helical blades and the two connecting members on the turbine's bearings. Torque testing on the turbine 1000 indicates that meaningful electricity generation can be achieved at a wind speed of about 5 mph.

A Prony Brake was used in the testing of the turbine 1000 to determine torque. During testing, a cable and belt was gradually pulled perpendicular to the turbine's rotating shaft, and the force pulling on the shaft was increased until the shaft would not turn to thus equalize against the force of the wind on the turbine's 360°-twist helical blades. The series of measurements registered on scales up to the point of equalization, and this yielded the maximum torque rating at a given wind speed. The torque was then converted to kilowatts of energy to arrive at the graph shown in FIG. 11.

What is claimed is:

1. A turbine comprising a rotatable shaft and three helical blades connected to the rotatable shaft, each of the three helical blades having a helical twist of about 360° or greater.

2. The turbine of claim 1 wherein the helical twist is 360°.

3. The turbine of claim 1 wherein rotation of the blades does not produce any measureable vibration.

4. The turbine of claim 1 wherein the rotatable shaft is connected to an electrical generator.
